(19) United States
(12) Patent Application Publication
(10) Pub. No.: US 2020/0013570 A1
(43) Pub. Date: Jan. 9, 2020

(54) SWITCHING APPARATUS

(71) Applicant: General Electric Technology GmbH, Baden (CH)

(72) Inventor: Colin Charnock DAVIDSON, Stafford (GB)

(21) Appl. No.: 16/470,013

(22) PCT Filed: Dec. 11, 2017
(86) PCT No.: PCT/EP2017/082133

§ 371 Date: Jun. 14, 2019

(30) Foreign Application Priority Data
Dec. 15, 2016 (EP) 16204364.0

(51) Int. Cl. H01H 33/59; H01H 9/54

(52) U.S. Cl. CPC H01H 33/596; H01H 9/548

(57) ABSTRACT

A switching apparatus comprises a plurality of parallel-connected current-conductive branches, each current-conductive branch including at least one respective gas tube switch, wherein the switching apparatus further includes an electrical circuit, the electrical circuit including at least one switching element configured to be operable to selectively synthesise a or a respective voltage difference in series with one or more of the gas tube switches so as to control the distribution of current between the current-conductive branches.

This invention relates to a switching apparatus, preferably for use in high voltage direct current (HVDC) applications.

It is known to use a switching apparatus that comprises a plurality of switches connected in parallel.

According to an aspect of the invention, there is provided a switching apparatus comprising a plurality of parallel-connected current-conductive branches, each current-conductive branch including at least one respective gas tube switch, wherein the switching apparatus further includes an electrical circuit, the electrical circuit including at least one switching element configured to be operable to selectively synthesise a or a respective voltage difference in series with one or more of the gas tube switches so as to control the distribution of current between the current-conductive branches.

It will be understood that, in the switching apparatus of the invention, each current-conductive branch may include a single gas tube switch or a plurality of gas tube switches (e.g. a plurality of series-connected gas tube switches).

Depending on the switching application, the current rating of a given gas tube switch may be too low to meet the current rating requirements of the switching application. The parallel connection of the current-conductive branches in the switching apparatus of the invention provides a “gas tube switch”-based switching apparatus with a combined current rating that is higher than the current rating of the individual gas tube switch, and thereby enables the use of gas tube switches in switching applications with higher current rating requirements.

In order to provide a reliable switching apparatus, it is necessary to control the sharing of current between the parallel-connected current-conductive branches.

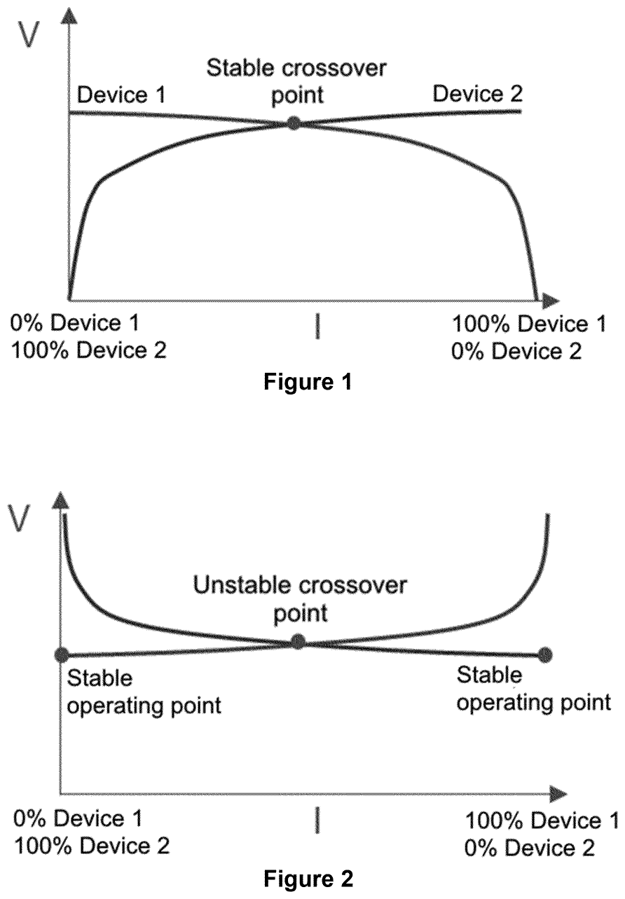

In a conventional switching apparatus based on parallel-connected power semiconductor switches, the positive slope resistances of the power semiconductor switches are such that current sharing between the parallel-connected power semiconductor switches occurs naturally to a degree, especially if the temperature coefficient is positive. FIG. 1 illustrates the stable current sharing between parallel-connected power semiconductor switches (which are referred to as Device 1 and Device 2 respectively), where there is a stable crossover point between their voltage-current characteristics. In addition, for certain types of power semiconductor switches, gate control can be employed to control the states of the parallel-connected power semiconductor switches in order to rebalance the currents flowing through the parallel-connected power semiconductor switches.

On the other hand, in a switching apparatus based on parallel-connected gas tube switches, it is not possible to obtain stable sharing of current between the parallel-connected gas tube switches. This is because, as shown in FIG. 2 which illustrates the unstable current sharing between parallel-connected gas tube switches, the stable operating points are when all of the current flows through one of the gas tube switches but zero current flows through the other gas tube switch. This is because the negative slope resistances of the gas tube switches are such that there is a tendency of the current to flow through only one or the other of the gas tube switches on either side of the unstable crossover point between their voltage-current characteristics. Moreover it would not be possible to rebalance the currents flowing through the parallel-connected gas tube switches through switching control due to the fact that gas tube switches only have fully-on and fully-off states.

The inclusion of the electrical circuit in the switching apparatus of the invention enables the stable sharing of current between the current-conductive branches based on gas tube switches. More particularly, the operation of the or each switching element to synthesise the or the respective voltage difference in series with one or more of the gas tube switches controls the flow of current in the or each corresponding current-conductive branch, which in turn enables the control of the distribution of current between all of the current-conductive branches. Preferably the control of the distribution of current between the current-conductive branches involves the balancing of the distribution of current between the current-conductive branches.

The configuration of the switching apparatus of the invention therefore provides a way of controlling the distribution of current between the current-conductive branches, thus beneficially improving the reliability of the “gas tube switch”-based switching apparatus.

The electrical circuit and its switching element(s) may vary in configuration in order to enable the synthesis of the or the respective voltage difference in series with one or more of the gas tube switches so as to control the distribution of current between the current-conductive branches.

In embodiments of the invention, the electrical circuit may include a plurality of electronic switching elements, each electronic switching element connected in a respective one of the current-conductive branches, each electronic switching element connected in series with the or each respective gas tube switch, each electronic switching element configured to function as a current-limiting diode.

The inclusion of a current-limiting diode in each current-conductive branch provides a passive mechanism of synthesising the respective voltage difference in series with each gas tube switch. Configuring each electronic switching element as a current-limiting diode allows the current flowing through the respective current-conductive branch, and through the respective gas tube switch(es), to rise up to a specific current level at which point it starts to level off. This has the effect of limiting the current flowing through the respective current-conductive branch to a maximum level.

Each electronic switching element may vary in configuration in order to function as a current-limiting diode (which is also known in the art as a “constant-current diode” or a “current-regulating diode”).

Each electronic switching element may be configured to have a non-linear voltage-current characteristic. The use of a non-linear voltage-current characteristic provides a reliable way of configuring each electronic switching element to function as a current-limiting diode.

Each electronic switching element may include at least one solid-state switching device. The use of solid-state switching devices to configure the electronic switching elements as current-limiting diodes provides a compact mechanism of synthesising the respective voltage difference in series with each gas tube switch.

Each solid-state switching device may be a junction field effect transistor (JFET). The structure of the JFET also provides a reliable way of configuring each electronic switching element to function as a current-limiting diode.

In further embodiments of the invention, the electrical circuit may include at least one voltage source and a switching control unit, the switching control unit configured to control the switching of the or each switching element to selectively switch the or each voltage source into circuit in or with one or more of the current-conductive branches so as to synthesise the or the respective voltage difference in series with one or more of the gas tube switches.

The inclusion of the or each voltage source and the switching control unit in the electrical circuit provides an active mechanism of synthesising the or the respective voltage difference in series with one or more of the gas tube switches. The active control of the switching of the or each switching element may be carried out in combination with the monitoring and measurement of the currents flowing in the current-conductive branches.

In further embodiments of the invention employing the use of at least one voltage source, the electrical circuit may include a current flow controller, the current flow controller including:
a plurality of terminals connected to the plurality of current-conductive branches such that each current-conductive branch is connected to at least one of the plurality of terminals; and
a current flow control unit interconnecting the plurality of terminals, the current flow control unit including the or each switching element and the or each voltage source,
wherein the switching control unit is configured to control the switching of the or each switching element to selectively switch the or each voltage source into circuit in or with one or more of the current-conductive branches so as to synthesise the or the respective voltage difference in series with one or more of the gas tube switches so as to simultaneously control the distribution of current between the current-conductive branches and divert energy from at least one current-conductive branch into at least one other current-conductive branch via the current flow control unit.

During the flow of current through the switching apparatus, at least one current-conductive branch may carry a higher current than at least one other current-conductive branch.

The synthesis of the or the respective voltage difference in series with one or more of the gas tube switches creates either a positive resistance effect in which the or the respective voltage difference opposes and thereby reduces the current flow in the corresponding current-conductive branch, or a negative resistance effect in which the or the respective voltage difference contributes to an increase of the current flow in the corresponding current-conductive branch.

The interconnection of the plurality of terminals via the current flow control unit permits energy to be transferred between the current-conductive branches via the current flow control unit. Thus, during the control of the distribution of current between the plurality of current-conductive branches, energy is removed from at least one current-conductive branch that is undergoing a reduction in current flow and this energy is diverted, via the current flow control unit, into at least one other current-conductive branch that is undergoing an increase in current flow.

Depending on the current sharing requirements of the switching apparatus, the current flow control unit may be used to divert energy from a single current-conductive branch to a single other current-conductive branch, from a single current-conductive branch to multiple other current-conductive branches, from multiple current-conductive branches to a single other current-conductive branch, or from multiple current-conductive branches to multiple other current-conductive branches.

In such embodiments of the invention, the or each switching element of the current flow control unit may be configured to be operable to selectively establish a current path through the current flow control unit between at least one current-conductive branch and at least one other current-conductive branch, and wherein the switching control unit may be configured to control the switching of the or each switching element to selectively establish the current path through the current flow control unit and to selectively switch the or each voltage source into circuit in or with one or more of the current-conductive branches in order to synthesise the or the respective voltage difference in series with one or more of the gas tube switches and thereby divert current through the current path from the at least one current-conductive branch to the at least one other current-conductive branch so as to simultaneously control the distribution of current between the current-conductive branches and divert energy from the at least one current-conductive branch into the at least one other current-conductive branch via the current path.

The ability to establish the current path through the current flow control unit enables the diversion of energy between current-conductive branches.

The current flow control unit may include a plurality of current flow control sub-units. Each current flow control sub-unit may be connected to a respective one of the current-conductive branches. Each current flow control sub-unit may include at least one switching element. The or each switching element of each current flow control sub-unit may be connected to a common voltage source. In a preferred embodiment of the invention the electrical circuit may include a single voltage source.

The use of a common voltage source to enable the synthesis of the or the respective voltage difference in series with one or more of the gas tube switches results in a more compact switching apparatus in comparison to a switching apparatus with multiple voltage sources.

The or each voltage source may include at least one energy storage device, the or each energy storage configured to be capable of storing and releasing energy to selectively provide a voltage. For example, the or each energy storage device may include at least one capacitor, at least one fuel cell, and/or at least one battery.

It will be appreciated that the switching apparatus of the invention may be used in a wide range of switching applications.

In a preferred embodiment of the invention, the switching apparatus may be configured for use in a HVDC application. In such an embodiment, the number of current-conductive branches of the switching apparatus may be configured so that the switching apparatus has a current rating suitable for a HVDC application.

The ability of the switching apparatus of the invention to control the distribution of current between the current-conductive branches improves the compatibility of gas tube switches with the high current rating requirements of HVDC applications.

Preferred embodiments of the invention will now be described, by way of non-limiting examples, with reference to the accompanying drawings in which:

FIG. 1 illustrates the current sharing characteristics of parallel-connected semiconductor switches;

FIG. 2 illustrates the current sharing characteristics of parallel-connected gas tube switches;

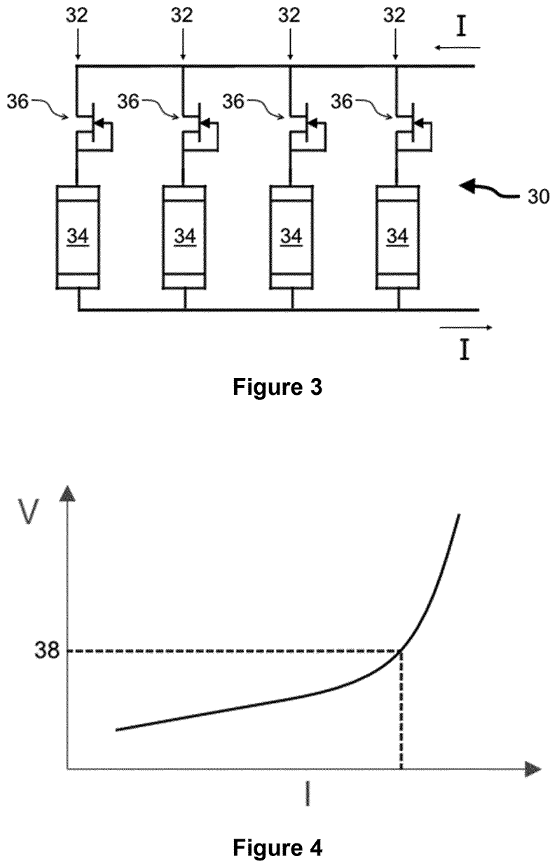

FIG. 3 shows schematically a switching apparatus according to a first embodiment of the invention;

FIG. 4 illustrates a non-linear voltage-current characteristic of a JFET in a current-limiting diode connection in which the source and gate are connected together;

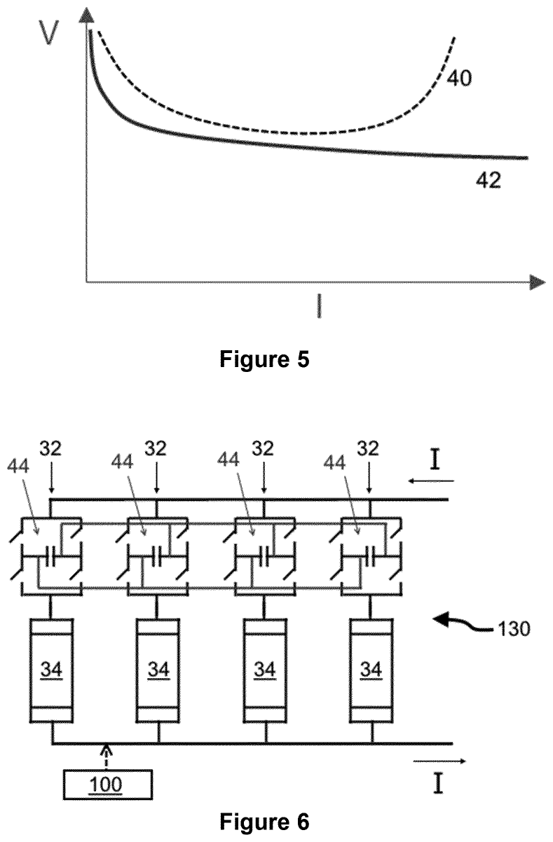

FIG. 5 illustrates the operation of a JFET as a current-limiting diode in the switching apparatus of FIG. 3;

FIG. 6 shows schematically a switching apparatus according to a second embodiment of the invention; and

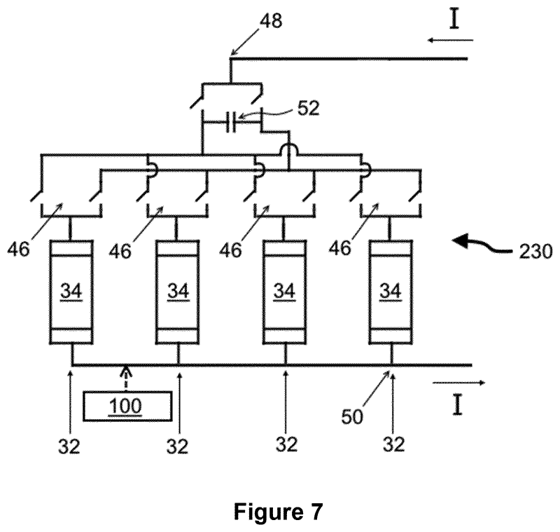

FIG. 7 shows schematically a switching apparatus according to a third embodiment of the invention.

The following embodiments of the invention are used primarily in HVDC applications, but it will be appreciated that the following embodiments of the invention are applicable mutatis mutandis to other switching applications.

A switching apparatus according to a first embodiment of the invention is shown in FIG. 3 and is designated generally by the reference numeral 30.

The switching apparatus 30 comprises a plurality of parallel-connected current-conductive branches 32. Each current-conductive branch 32 includes a respective gas tube switch 34. Each gas tube switch 34 includes a chamber enclosing an ionizable gas, and is configured to generate a plasma of ionized gas to facilitate a controlled current flow through the gas tube switch 34. In the embodiment shown, there are four current-conductive branches 32, but it will be appreciated that the number of current-conductive branches 32 of the switching apparatus 30 may vary.

The switching apparatus 30 further includes an electrical circuit, which includes a plurality of electronic switching elements. Each electronic switching element is connected in a respective one of the current-conductive branches 32.

FIG. 4 illustrates the general non-linear voltage-current characteristic of a JFET 36 in a current-limiting diode connection.

Each electronic switching element is in the form of a JFET 36 that is connected in series and in constant-current connection with the respective gas tube switch 34. In each JFET 36, a source and a gate of the JFET 36 are permanently connected. The connection between the source and the gate of the JFET 36 may be implemented by means of a low or zero impedance. In other embodiments however, it is envisaged that the connection between the source and the gate of the JFET 36 may be implemented by means of a controlled resistive impedance.

Permanently connecting the source and gate of the JFET 36 leads to the formation of a current-limiting diode exhibiting a non-linear resistive and current limiting function in one direction of current and voltage. This is because the device depletion layer widens to pinch off the current while, in the reverse direction of current and voltage, the device depletion layer shrinks, which has the effect of lowering impedance and improving current flow.

The foregoing non-linear voltage-current characteristic of each JFET 36 is such that the resistance of each JFET 36 to current flow increases non-linearly with voltage until a pinch-off voltage 38 is reached, at which point the current flowing through each JFET 36 starts to level off. This has the effect of limiting the current flowing through the JFET 36 to a maximum level. In this manner each JFET 36 is configured to function as a current limiting diode.

It will be appreciated that the general non-linear voltage-current characteristic of the JFET 36 in the current-limiting diode connection as shown in FIG. 4 is intended to help illustrate the function of the JFET 36 as a current-limiting diode, but the in-use non-linear voltage-current characteristic of the JFET 36 in the current-limiting diode connection may be more complex from what is shown in FIG. 4 as a result of the gate being connected to a gate drive.

The ability of each JFET 36 to function as a current-limiting diode enables it to passively synthesise a respective voltage difference in series with each gas tube switch 34. As illustrated in FIG. 5, the constant-current and series connection of the JFET 36 and gas tube switch 34 in a given current-conductive branch 32 means that the synthesis of the voltage difference in series with the gas tube switch 34 has the effect of limiting the maximum level of the current flowing through the current-conductive branch 32 (as indicated by the dashed line 40) where the maximum level is set by the voltage-current characteristic of the JFET 36, as opposed to the normal voltage-current characteristic of the gas tube switch 34 (as indicated by the solid line 42).

By configuring each JFET 36 to function as a current-limiting diode to passively synthesise a respective voltage difference in series with each gas tube switch 34, it becomes possible to control the flow of current in each current-conductive branch 32 in a manner that enables the balancing of the distribution of current I between all of the current-conductive branches 32.

The configuration of the switching apparatus 30 of FIG. 3 therefore provides a way of providing a stable sharing of current I between the current-conductive branches 32 based on gas tube switches 34.

It is envisaged that, in other embodiments of the invention, each JFET 36 may be replaced by a plurality of JFETs 36, preferably a plurality of parallel-connected JFETs 36. It is also envisaged that, in other embodiments of the invention, each JFET 36 may be replaced by another type of solid-state switching device that enables the configuration of each electronic switching element as a current-limiting diode.

A switching apparatus according to a second embodiment of the invention is shown in FIG. 6 and is designated generally by the reference numeral 130.

The switching apparatus 130 comprises a plurality of parallel-connected current-conductive branches 32. Each current-conductive branch 32 includes a respective gas tube switch 34. Each gas tube switch 34 includes a chamber enclosing an ionizable gas, and is configured to generate a plasma of ionized gas to facilitate a controlled current flow through the gas tube switch 34. In the embodiment shown, there are four current-conductive branches 32, but it will be appreciated that the number of current-conductive branches 32 of the switching apparatus 130 may vary.

The switching apparatus 130 further includes an electrical circuit, which includes a current flow controller and a switching control unit 100.

The current flow controller comprises a plurality of terminals and a current flow control unit.

In the embodiment shown, the plurality of terminals defines four pairs of terminals, each of which is connected in a respective one of the current-conductive branches 32.

The current flow control unit includes four current flow control sub-units 44. Each current flow control sub-unit 44 includes two pairs of switching elements connected in parallel with a respective capacitor in a full-bridge arrangement.

Each switching element of the current flow control unit is constituted by a semiconductor device in the form of an Insulated Gate Bipolar Transistor (IGBT). Each switching element also includes an anti-parallel diode connected in parallel therewith.

In other embodiments of the invention (not shown), it is envisaged that each switching element of the current flow control unit may be or may include a different semiconductor device such as a gate turn-off thyristor, a field effect transistor, an injection-enhanced gate transistor, an integrated gate commutated thyristor or any other self-commutated semiconductor device.

It is also envisaged that, in other embodiments of the invention (not shown), each capacitor may be replaced by a different energy storage device, such as a fuel cell, a battery or any other energy storage device capable of storing and releasing energy to selectively provide a voltage.

Each current flow control sub-unit 44 is connected in a respective one of the current-conductive branches 32 so as to be connected in series between the respective pair of terminals. In this manner, each current flow control sub-unit 44 is connected in series with the respective gas tube switch 34.

In use, the capacitor of each current flow control sub-unit 44 may be selectively bypassed or inserted into circuit in the respective current-conductive branch 32 by changing the states of the corresponding switching elements. The switching control unit 100 is configured to control the switching of the switching elements of the current flow control sub-units 44.

The capacitor of a given current flow control sub-unit 44 is bypassed when the corresponding switching elements are configured to form a short circuit that permits a current flowing in the corresponding current-conductive branch 32 to bypass the capacitor. This in turn means that the current flow control sub-unit 44 does not synthesise any voltage difference in series with the corresponding gas tube switch 34.

The capacitor of a given current flow control sub-unit 44 is inserted into circuit in the respective current-conductive branch 32 when the corresponding switching elements are configured to provide a path for a current flowing in the current-conductive branch 32 to flow into and out of the capacitor. The capacitor then charges or discharges its stored energy so as to synthesise a voltage difference in series with the corresponding gas tube switch 34. The full-bridge arrangement of the current flow control sub-unit 44 enables the capacitor to be inserted into circuit in the respective current-conductive branch 32 in either forward or reverse directions so as to synthesise a positive or negative voltage difference in series with the corresponding gas tube switch 34.

The capacitors are connected in parallel with each other to electrically couple the current flow control sub-units 44 so as to permit transfer of energy, in use, between the current flow control sub-units 44. The interconnection of the control flow control sub-units 44 in this manner enables the operation of the switching elements to selectively establish a current path through the current flow control unit between at least one current-conductive branch 32 and at least one other current-conductive branch 32.

During the flow of current through the switching apparatus 130, at least one current-conductive branch 32 may carry a higher current than at least one other current-conductive branch 32 due to the unstable current sharing of the gas tube switches 34.

To reduce the current in a current-conductive branch 32, the switching control unit 100 switches the switching elements of the corresponding current flow control sub-unit 44 to synthesise a voltage difference in series with the corresponding gas tube switch 34. The polarity of the voltage difference is set so that the synthesis of the voltage difference in series with the corresponding gas tube switch 34 creates a positive resistance effect in which the voltage difference opposes and thereby reduces the current flowing in the current-conductive branch 32.

At the same time, to increase the current in another current-conductive branch 32, the switching control unit 100 switches the switching elements of the corresponding current flow control sub-unit 44 to synthesise a voltage difference in series with the corresponding gas tube switch 34. The polarity of the voltage difference is set so that the synthesis of the voltage difference in series with the corresponding gas tube switch 34 creates a negative resistance effect in which the voltage difference contributes to an increase of the current flowing in the current-conductive branch 32.

Meanwhile, the synthesis of the respective voltage differences in series with the corresponding gas tube switches 34 together with the formation of the current path through the current flow control unit allows energy to be transferred between the current-conductive branches 32 via the current flow control unit. More particularly, energy is removed from the or each current-conductive branch 32 that is undergoing a reduction in current flow, and this energy is diverted via the current path to the or each current-conductive branch 32 that is undergoing an increase in current flow. Such operation of the current flow controller effectively diverts current through the current path from at least one current-conductive branch 32 to at least one other current-conductive branch 32, which in turn permits the balancing of the distribution of current I between the current-conductive branches 32.

The configuration of the switching apparatus 130 of FIG. 6 therefore provides a way of actively providing a stable sharing of current I between the current-conductive branches 32 based on gas tube switches 34.

The above balancing of the distribution of current I between the current-conductive branches 32 is preferably carried out in combination with the use of current sensors (such as Rogowski coils) to monitor and measure the currents flowing in the current-conductive branches 32. This allows the switching control unit 100 to initiate the synthesis of the respective voltage differences in series with the corresponding gas tube switches 34 and the formation of the current path through the current flow control unit when an imbalance in the currents flowing in the current-conductive branches 32 is detected.

It will be appreciated that the configuration of the current flow controller may vary. In particular, the number of switching elements and capacitors, as well as their arrangement, may vary so long as the current flow controller is configured to enable synthesis of the respective voltage differences in series with the corresponding gas tube switches 34 and the formation of the current path through the current flow control unit.

For example, instead of having a respective capacitor in each current flow control sub-unit 44, two or more of the current flow control sub-units 44 may share a common capacitor, where the switching elements of each such current flow control sub-unit 44 is connected in parallel with the common capacitor in a respective full-bridge arrangement.

A switching apparatus according to a third embodiment of the invention is shown in FIG. 7 and is designated generally by the reference numeral 230.

The switching apparatus 230 comprises a plurality of current-conductive branches 32 connected between first and second ports 48,50, which are configured to permit current to flow into and out of the switching apparatus 230.

Each current-conductive branch 32 includes a respective gas tube switch 34. Each gas tube switch 34 includes a chamber enclosing an ionizable gas, and is configured to generate a plasma of ionized gas to facilitate a controlled current flow through the gas tube switch 34. In the embodiment shown, there are four current-conductive branches 32, but it will be appreciated that the number of current-conductive branches 32 of the switching apparatus 230 may vary.

The switching apparatus 230 further includes an electrical circuit, which includes a current flow controller and a switching control unit 100.

The current flow controller comprises a plurality of terminals and a current flow control unit.

In the embodiment shown, the plurality of terminals defines four terminals, each of which is connected to a first end of a respective one of the current-conductive branches 32. Meanwhile a second end of each current-conductive branch 32 is connected to the second port 50 of the switching apparatus 230.

The current flow control unit includes a single capacitor 52 and four current flow control sub-units 46. Each current flow control sub-unit 46 includes a respective pair of switching elements. A mid-point between the pair of switching elements of each current flow control sub-unit 46 is connected to a respective one of the plurality of terminals which are respectively connected to the first ends of the current-conductive branches 32. The pair of switching elements of each current flow control sub-unit 46 is connected in parallel with the single capacitor 52, i.e. the switching elements of each current flow control sub-unit 46 is connected to a common capacitor 52.

The current flow control unit further includes a further pair of switching elements connected in parallel with the single capacitor 52. A mid-point between the further pair of switching elements is connected to the first port 48 of the switching apparatus.

The above arrangement of the switching elements of the current flow control unit permits their switching in order to configure the current-conductive branches 32 to be connected in parallel between the first and second ports 48,50 of the switching apparatus 230.

Each switching element of the current flow control unit is constituted by a semiconductor device in the form of an Insulated Gate Bipolar Transistor (IGBT). Each switching element also includes an anti-parallel diode connected in parallel therewith.

In other embodiments of the invention (not shown), it is envisaged that each switching element of the current flow control unit may be or may include a different semiconductor device such as a gate turn-off thyristor, a field effect transistor, an injection-enhanced gate transistor, an integrated gate commutated thyristor or any other self-commutated semiconductor device.

It is also envisaged that, in other embodiments of the invention (not shown), the capacitor may be replaced by a different energy storage device, such as a fuel cell, a battery or any other energy storage device capable of storing and releasing energy to selectively provide a voltage.

Each current flow control sub-unit 46 is connected to a respective one of the current-conductive branches 32 so as to be connected in series with the respective gas tube switch 34.

In use, the capacitor 52 may be selectively bypassed or inserted into circuit with one or more of the current-conductive branches 32 by changing the states of the corresponding switching elements. The switching control unit 100 is configured to control the switching of the switching elements of the current flow control sub-units 46 as well as the switching of the further pair of switching elements.

The capacitor is bypassed with respect to a given current-conductive branch 32 when the corresponding switching elements are configured to form a short circuit that permits a current flowing in the corresponding current-conductive branch 32 to bypass the capacitor 52. This in turn means that the current flow control sub-unit 46 does not synthesise any voltage difference in series with the corresponding gas tube switch 34.

The capacitor 52 is inserted into circuit with a given current-conductive branch 32 when the corresponding switching elements are configured to provide a path for a current flowing in the current-conductive branch 32 to flow into and out of the capacitor 52. The capacitor then charges or discharges its stored energy so as to synthesise a voltage difference in series with the corresponding gas tube switch 34. The arrangement of the switching elements in the current flow control unit enables the capacitor 52 to be inserted into circuit with a given current-conductive branch 32 in either forward or reverse directions so as to synthesise a positive or negative voltage difference in series with the corresponding gas tube switch 34.

The connection of the switching elements of the current flow control sub-units 46 with the common capacitor 52 permits transfer of energy, in use, between the current flow control sub-units 44 through the establishment of a current path through the current flow control unit between at least one current-conductive branch 32 and at least one other current-conductive branch 32.

During the flow of current through the switching apparatus 230, at least one current-conductive branch 32 may carry a higher current than at least one other current-conductive branch 32 due to the unstable current sharing of the gas tube switches 34.

To reduce the current in a current-conductive branch 32, the switching control unit 100 switches the switching elements of the corresponding current flow control sub-unit 46 to synthesise a voltage difference in series with the corresponding gas tube switch 34. The polarity of the voltage difference is set so that the synthesis of the voltage difference in series with the corresponding gas tube switch 34 creates a positive resistance effect in which the voltage difference opposes and thereby reduces the current flowing in the current-conductive branch 32. This has the effect of indirectly increasing the current flowing in one or more other current-conductive branches 32 for which there is no synthesis of a voltage difference in series with the corresponding gas tube switch 34.

To increase the current in a current-conductive branch 32, the switching control unit 100 switches the switching elements of the corresponding current flow control sub-unit 46 to synthesise a voltage difference in series with the corresponding gas tube switch 34. The polarity of the voltage difference is set so that the synthesis of the voltage difference in series with the corresponding gas tube switch 34 creates a negative resistance effect in which the voltage difference contributes to an increase of the current flowing in the current-conductive branch 32. This has the effect of indirectly decreasing the current flowing in one or more other current-conductive branches 32 for which there is no synthesis of a voltage difference in series with the corresponding gas tube switch 34.

Meanwhile the formation of the current path through the current flow control unit allows energy to be transferred between the current-conductive branches 32 via the current flow control unit. More particularly, energy is removed from the or each current-conductive branch 32 that is undergoing a reduction in current flow, and this energy is diverted via the current path to the or each current-conductive branch 32 that is undergoing an increase in current flow. Such operation of the current flow controller effectively diverts current through the current path from at least one current-conductive branch 32 to at least one other current-conductive branch 32, which in turn permits the balancing of the distribution of current I between the current-conductive branches 32.

The configuration of the switching apparatus 230 of FIG. 7 therefore provides a way of actively providing a stable sharing of current I between the current-conductive branches 32 based on gas tube switches 34.

The above balancing of the distribution of current I between the current-conductive branches 32 is preferably carried out in combination with the use of current sensors (such as Rogowski coils) to monitor and measure the currents flowing in the current-conductive branches 32. This allows the switching control unit 100 to initiate the synthesis of the respective voltage differences in series with the corresponding gas tube switches 34 and the formation of the current path through the current flow control unit when an imbalance in the currents flowing in the current-conductive branches 32 is detected.

1. A switching apparatus comprising a plurality of parallel-connected current-conductive branches, each current-conductive branch including at least one respective gas tube switch, wherein the switching apparatus further includes an electrical circuit, the electrical circuit including at least one switching element configured to be operable to selectively synthesise a or a respective voltage difference in series with one or more of the gas tube switches so as to control the distribution of current (I) between the current-conductive branches.

2. The switching apparatus according to claim 1 wherein the control of the distribution of current (I) between the current-conductive branches involves the balancing of the distribution of current (I) between the current-conductive branches.

3. The switching apparatus according to claim 1 wherein the electrical circuit includes a plurality of electronic switching elements, each electronic switching element connected in a respective one of the current-conductive branches, each electronic switching element connected in series with the or each respective gas tube switch, each electronic switching element configured to function as a current-limiting diode.

4. The switching apparatus according to claim 3 wherein each electronic switching element is configured to have a non-linear voltage-current characteristic.

5. The switching apparatus according to claim 3 wherein each electronic switching element includes at least one solid-state switching device.

6. The switching apparatus according to claim 5 wherein each solid-state switching device is a junction field effect transistor.

7. The switching apparatus according to claim 1 wherein the electrical circuit includes at least one voltage source and a switching control unit, the switching control unit configured to control the switching of the or each switching element to selectively switch the or each voltage source into circuit in or with one or more of the current-conductive branches so as to synthesise the or the respective voltage difference in series with one or more of the gas tube switches.

8. The switching apparatus according to claim 7 wherein the electrical circuit includes a current flow controller, the current flow controller comprising:
a plurality of terminals connected to the plurality of current-conductive branches such that each current-conductive branch is connected to at least one of the plurality of terminals; and
a current flow control unit interconnecting the plurality of terminals, the current flow control unit including the or each switching element and the or each voltage source,
wherein the switching control unit is configured to control the switching of the or each switching element to selectively switch the or each voltage source into circuit in or with one or more of the current-conductive branches so as to synthesise the or the respective voltage difference in series with one or more of the gas tube switches so as to simultaneously control the distribution of current (I) between the current-conductive branches and divert energy from at least one current-conductive branch into at least one other current-conductive branch via the current flow control unit.

9. The switching apparatus according to claim 8 wherein the or each switching element of the current flow control unit is configured to be operable to selectively establish a current path through the current flow control unit between at least one current-conductive branch and at least one other current-conductive branch, and wherein the switching control unit is configured to control the switching of the or each switching element to selectively establish the current path through the current flow control unit and to selectively switch the or each voltage source into circuit in or with one or more of the current-conductive branches in order to synthesise the or the respective voltage difference in series with one or more of the gas tube switches and thereby divert current through the current path from the at least one current-conductive branch to the at least one other current-conductive branch so as to simultaneously control the distribution of current (I) between the current-conductive branches and divert energy from the at least one current-conductive branch into the at least one other current-conductive branch via the current path.

10. The switching apparatus according to claim 8 wherein the current flow control unit includes a plurality of current flow control sub-units, each current flow control sub-unit connected to a respective one of the current-conductive branches, each current flow control sub-unit including at least one switching element, the or each switching element of each current flow control sub-unit connected to a common voltage source.

11. The switching apparatus according to claim 10 wherein the electrical circuit includes a single voltage source.

12. The switching apparatus according to claim 1 wherein the or each voltage source includes at least one energy storage device, the or each energy storage configured to be capable of storing and releasing energy to selectively provide a voltage.

13. The switching apparatus according to claim 12 wherein the or each energy storage device includes at least one capacitor, at least one fuel cell, and/or at least one battery.

14. The switching apparatus according to claim 1 wherein the number of current-conductive branches of the switching apparatus is configured so that the switching apparatus has a current rating suitable for a high voltage direct current application.
